(19) United States
(12) Patent Application Publication
(10) Pub. No.: US 2026/0359419 A1
(43) Pub. Date: Nov. 12, 2026

(54) COMPUTER-READABLE STORAGE MEDIUM, METHOD, AND INFORMATION PROCESSING DEVICE FOR DISPLAYING RESTRICTION INFORMATION WHEN AN OS SETTING RESTRICTS USE OF A DEVICE DRIVER

(71) Applicant: BROTHER KOGYO KABUSHIKI KAISHA, Nagoya (JP)

(72) Inventor: Norihiko ASAI, Tajimi (JP)

(21) Appl. No.: 19/560,900

(22) Filed: Mar. 9, 2026

(30) Foreign Application Priority Data
Mar. 10, 2025 (JP) 2025-037443

(51) Int. Cl. G06F 21/51

(52) U.S. Cl. CPC G06F 21/51

(57) ABSTRACT

A non-transitory computer-readable storage medium stores computer-readable instructions that are executable by a processor of an information processing device. The information processing device includes a user interface and an operating system (OS). The computer-readable instructions are configured to, when executed by the processor, cause the information processing device to determine whether an OS setting is enabled. The OS setting is a setting of the OS for restricting use of a device driver provided by a vendor of an image processing device. The computer-readable instructions are further configured to, when executed by the processor, cause the information processing device to, in response to determining that the OS setting is enabled, cause the user interface to display restriction information regarding a restriction on the use of the device driver.

### REFERENCE TO RELATED APPLICATIONS

This application claims priority from Japanese Patent Application No. 2025-037443 filed on Mar. 10, 2025. The entire content of the priority application is incorporated herein by reference.

### BACKGROUND ART

In recent years, some operating systems (hereinafter referred to as “OSs”) have introduced settings for restricting the use of device drivers provided by vendors of image processing devices. One example of such OS settings is Windows Protected Print Mode (hereinafter referred to as “WPP”) introduced into Windows (“Windows” is a registered trademark of Microsoft Corporation). When WPP is enabled, the device drivers provided by the vendors of image processing devices are deleted and become unavailable.

### SUMMARY

In the known configuration, when WPP is enabled, the device drivers are deleted. As a result of the deletion, for instance, users and programs that use those device drivers are affected.

According to aspects of the present disclosure, a non-transitory computer-readable storage medium is provided, which stores computer-readable instructions that are executable by a processor of an information processing device. The information processing device includes a user interface and an operating system (OS). The computer-readable instructions are configured to, when executed by the processor, cause the information processing device to determine whether an OS setting is enabled. The OS setting is a setting of the OS for restricting use of a device driver provided by a vendor of an image processing device. The computer-readable instructions are further configured to, when executed by the processor, cause the information processing device to, in response to determining that the OS setting is enabled, cause the user interface to display restriction information regarding a restriction on the use of the device driver.

According to aspects of the present disclosure, further provided is a method implementable on a processor of an information processing device. The information processing device includes a user interface and an operating system (OS). The method includes determining whether an OS setting is enabled. The OS setting is a setting of the OS for restricting use of a device driver provided by a vendor of an image processing device. The method further includes causing, in response to determining that the OS setting is enabled, the user interface to display restriction information regarding a restriction on the use of the device driver.

According to aspects of the present disclosure, further provided is an information processing device that includes a user interface and a controller. The controller includes an operating system (OS). The controller is configured to determine whether an OS setting is enabled. The OS setting is a setting of the OS for restricting use of a device driver provided by a vendor of an image processing device. The controller is further configured to, in response to determining that the OS setting is enabled, cause the user interface to display restriction information regarding a restriction on the use of the device driver.

### BRIEF DESCRIPTION OF DRAWINGS

FIG. 1 is a block diagram illustrating a schematic configuration of a PC (i.e., an abbreviation for “Personal Computer”).

FIGS. 2A and 2B are flowcharts illustrating an example procedure of an installation setting process.

FIG. 3 illustrates an example of a first selection screen for selecting installation targets.

FIG. 4 illustrates an example of a guidance screen for disabling a protection mode.

FIG. 5 illustrates a modification of the first selection screen.

FIG. 6 illustrates an example of a second selection screen for selecting installation targets.

FIG. 7 illustrates an example of a caution screen for prompting attention regarding a case where the protection mode is enabled.

FIG. 8 illustrates an example of a notification screen displayed via a status monitor.

FIG. 9 is a flowchart illustrating an example procedure of a protection-mode checking process by the status monitor.

FIG. 10 illustrates an example display when a protection-mode check button is operated on the notification screen with the protection mode enabled.

FIG. 11 illustrates an example display when the protection-mode check button is operated on the notification screen with the protection mode disabled.

FIG. 12 illustrates an example of a home screen displayed via an image processing application.

FIG. 13 illustrates an example display when a protection-mode check button is operated on the home screen with the protection mode enabled.

FIG. 14 illustrates an example display when the protection-mode check button is operated on the home screen with the protection mode disabled.

FIG. 15 is a flowchart illustrating an example procedure of a protection-mode monitoring process.

FIG. 16 illustrates an example of a notice screen when the protection mode has become enabled.

FIG. 17 is a flowchart illustrating an example procedure of a modification of the protection-mode monitoring process.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR—meaning that it includes either A, B, or both—may be expressed as “A and/or B,” “at least one of A or B,” or “at least one selected from the group consisting of A and B.” Additionally, the expressions “one of A or B” and “either A or B,” as used herein, refer to a case where A or B is selected exclusively, but not both. The same interpretation applies in cases where three or more selectable elements are considered.

Hereinafter, programs and a control method using the programs in an illustrative embodiment according to aspects of the present disclosure will be described in detail with reference to the accompanying drawings. In the following description, programs incorporated into a PC (i.e., an abbreviation for “Personal Computer”) will be disclosed.

### Configuration of PC

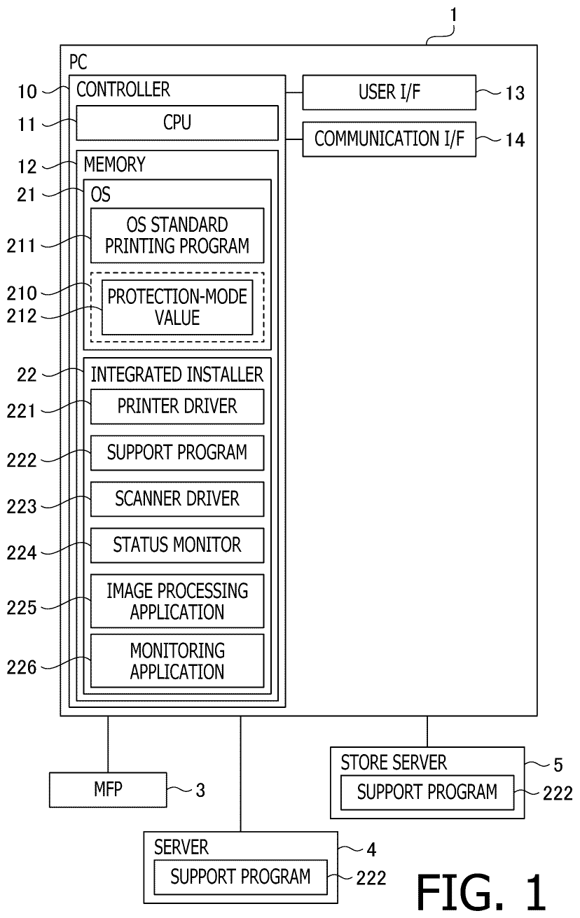

As illustrated in FIG. 1, a PC 1 of the illustrative embodiment includes a controller 10 that includes a CPU 11 and a memory 12. The PC 1 further includes a user I/F (i.e., an abbreviation for “interface”) 13 and a communication I/F 14, which are electrically connected to the controller 10. The PC 1 may be an example of an “information processing device” according to aspects of the present disclosure. Examples of the information processing device may include, but are not limited to, a tablet computer and a smartphone, in addition to the PC 1.

The CPU 11 is configured to perform various processes in accordance with programs read from the memory 12 and based on user operations. The memory 12 stores various programs and various types of data. The memory 12 may be used, for instance, as a work area when various programs are executed. Examples of the memory 12 may include, but are not limited to, a buffer provided in the CPU 11, and computer-readable storage media such as a CD-ROM, a DVD-ROM, and a USB memory. The CPU 11 may also use various programs and data read from a computer-readable storage medium.

The memory 12 stores various programs and various types of data, including an operating system (hereinafter may be referred to as an “OS”) 21 and an integrated installer 22. The integrated installer 22 may be an example of “computer-readable instructions” according to aspects of the present disclosure. Details of the programs and data will be described later. The controller 10 shown in FIG. 1 is a general term collectively referring to hardware and software used to control the PC 1, and may not necessarily represent a single piece of hardware actually present in the PC 1.

The user I/F 13 includes hardware configured to display screens for notifying the user of information and hardware configured to receive user operations. Examples of the hardware configured to display screens may include, but are not limited to, various types of displays such as a liquid crystal display and an organic EL display. The user I/F 13 may include at least one of a display, a mouse, or a keyboard. The user I/F 13 may include a touch panel having both the hardware configured to display screens and the hardware configured to receive user operations.

The communication I/F 14 includes hardware configured to communicate with external devices. The communication I/F 14 has functions compatible with communication standards such as Wi-Fi (“Wi-Fi” is a registered trademark of the non-profit Wi-Fi Alliance), Ethernet (“Ethernet” is a registered trademark of Fuji Xerox Co., Ltd.), and USB. The PC 1 may include a plurality of communication I/Fs 14 compatible with a plurality of communication standards.

The PC 1 of the illustrative embodiment is connectable to a multi-function peripheral (hereinafter referred to as an “MFP”) 3 via the communication I/F 14, as illustrated in FIG. 1. The MFP 3 is a device having at least a printing function, a reading function, and a communication function. The printing function is a function of printing an image on a medium such as a sheet. The reading function is a function of reading an image from an original document. The MFP 3 may be an example of an image processing device according to aspects of the present disclosure. Examples of the image processing device may include, but are not limited to, a copying machine, a printer, an image scanner, and a facsimile machine, in addition to the MFP 3. A plurality of image processing devices may be connected to the PC 1. In the present disclosure, an image processing device having the printing function may be referred to as a “printing device.” In this case, examples of the printing device may include an MFP.

The OS 21 of the PC 1 is a multitasking operating system configured to process a plurality of tasks in parallel by managing and switching among the tasks. In the illustrative embodiment, the OS 21 of the PC 1 is Windows (“Windows” is a registered trademark of Microsoft Corporation). The OS 21 includes a printing program 211, which is an OS standard printing program. That is, the PC 1 includes the OS 21 that includes the OS standard printing program 211.

The OS standard printing program 211 is a standard printer driver provided by a vendor of the OS 21 as part of the OS 21. The OS standard printing program 211 may also be referred to as a program installed as a standard component of the OS 21 or as a program pre-installed in the OS 21. The OS standard printing program 211 is, for instance, packaged together with the OS 21 and installed on the PC 1 together with the OS 21.

The OS standard printing program 211 is compatible with a plurality of models of printing devices provided by respective vendors, and is configured to cause various printing devices to perform printing. The OS standard printing program 211 is a program, such as an IPP class driver, configured to communicate with various printing devices in accordance with IPP (i.e., an abbreviation for “Internet Printing Protocol”). The OS standard printing program 211 is further configured to provide general functions that enable printing by various printing devices.

The OS standard printing program 211 is further configured to receive, based on user instructions, image data specified as print targets in print instructions output from various application programs (hereinafter may be referred to as “applications”) and to generate intermediate data based on the received image data. Examples of the intermediate data may include, but are not limited to, XPS data. The OS standard printing program 211 is further configured to generate, based on the intermediate data, print data in a format usable for printing by various printing devices. Examples of the print data may include, but are not limited to, PWG Raster data and PDF data. The OS standard printing program 211 is further configured to transmit the generated print data, using a communication function of the OS 21, to a printing device designated to perform printing.

The OS 21 further includes a protection mode, which is a mode for restricting the use of device drivers provided by vendors of various types of devices. The OS 21 may accept, for instance based on user operations, a setting as to whether the protection mode is to be enabled. The protection-mode setting is an example of an OS setting. When the protection mode is enabled, for instance, the use of all device drivers provided by vendors of image processing devices may be restricted. In another instance, the use of device drivers for some functions may be restricted while the use of device drivers for other functions is not restricted. As an example of the protection mode, there is, for instance, WPP (i.e., an abbreviation for “Windows Protected Print Mode”) introduced in Windows 11 provided by Microsoft Corporation. In WPP, at least the use of a printer driver provided by a vendor of a printing device is restricted. In the protection mode of the illustrative embodiment, the OS 21 restricts the use of a printer driver and does not restrict the use of a scanner driver, in substantially the same manner as WPP. Hereinafter, unless otherwise noted, the term “printer driver” refers to a printer driver provided by a vendor of a printing device.

A setting value (hereinafter referred to as a “protection-mode value”) 212 indicating whether the protection mode is enabled is stored, for instance, in a particular storage area 210 managed by the OS 21. The protection-mode value 212 is an example of setting information. Hereinafter, “the protection-mode value 212 is ON” means that the protection mode is enabled, and “the protection-mode value 212 is OFF” means that the protection mode is not enabled. Examples of the particular storage area 210 managed by the OS 21 may include, but are not limited to, a registry.

In the illustrative embodiment, when the protection mode becomes enabled with a vendor-provided printer driver installed on the PC 1, the OS 21 uninstalls the printer driver. Uninstalling the printer driver may be regarded as deleting the printer driver. Further, when the protection mode is enabled, the OS 21 restricts installation of the printer driver. Even when the protection mode becomes enabled, the OS 21 does not restrict the use of the OS standard printing program 211. That is, the OS standard printing program 211 is usable regardless of whether the protection mode is enabled. On the other hand, when the protection mode is disabled, neither installation nor use of the printer driver is restricted.

An integrated installer 22 is a program executable by the PC 1 and is separate from the OS 21. The integrated installer 22 is a Win32 application provided by the vendor of the MFP 3 and is configured to install, in response to a user instruction, various programs for controlling the MFP 3 from the PC 1. The various programs installed by the integrated installer 22 are provided by the vendor of the MFP 3. The integrated installer 22 is executed, for instance, when the MFP 3 is newly connected to the PC 1.

In the illustrative embodiment, the integrated installer 22 includes, for instance, as illustrated in FIG. 1, a printer driver 221, a support program 222, a scanner driver 223, a status monitor 224, an image processing application 225, and a monitoring application 226. The printer driver 221 and the scanner driver 223 are examples of device drivers for controlling the MFP 3 and are specific to the MFP 3.

The printer driver 221 is, for instance, a program configured to cause the MFP 3 to perform printing and to support each function relating to printing that the MFP 3 provides. The scanner driver 223 is, for instance, a program configured to cause the MFP 3 to perform reading and to support each function relating to reading that the MFP 3 provides. In contrast, the OS standard printing program 211 included in the OS 21, unlike a printer driver specific to a printing device, does not support functions specific to the printing device and/or the printer driver, particularly functions that require complicated processing. When printing is performed using the OS standard printing program 211, the PC 1 does not use the printer driver 221.

The support program 222 may include one or more programs configured to support, in cooperation with the OS standard printing program 211, processing performed by the OS standard printing program 211. The support program 222 is configured to support control of the MFP 3 by the OS standard printing program 211. If the support program 222 is installed on the PC 1, the OS standard printing program 211 may activate the support program 222 corresponding to the MFP 3, for instance, in response to a selection of the MFP 3, in response to receipt of an instruction regarding print settings for printing by the MFP 3, or in response to receipt of a print instruction for causing the MFP 3 to perform printing. The support program 222 may also be referred to as a “PSA” (i.e., an abbreviation for “Printing Support Application”) or an “HSA” (i.e., an abbreviation for “Hardware Support Application”).

The support program 222 may be a combination of a plurality of programs, each configured to receive an execution command, or may be a single program configured to execute respective processes in response to different instructions. The support program 222 may be compatible with a plurality of printers. For instance, a vendor may provide the support program 222 for each type of printer. For instance, separate support programs may be provided for an inkjet printer and for a laser printer. In addition to, or instead of, being provided for each type of printer, the support program 222 may be provided for each printer model or for each series of printer models.

The status monitor 224 is a program executable by the PC 1. The status monitor 224 is configured to acquire various types of information from the MFP 3 connected via the communication I/F 14, and to provide, via the user I/F 13, notifications of the information acquired from the MFP 3. If another image processing device provided by the vendor of the MFP 3 is connected to the PC 1, the other image processing device may also fall within the monitoring scope of the status monitor 224.

The status monitor 224 is a resident program configured to be automatically activated in response to startup of the OS 21. The status monitor 224 is further configured to cause, while the OS 21 is running, the PC 1 to perform periodic communications with one or more image processing devices under monitoring in the background. Through communications with the MFP 3, the status monitor 224 acquires, for instance, capability information, status information, various types of setting information set in the MFP 3, remaining amounts of consumables possessed by the MFP 3, and information regarding progress of printing and reading. When one or more particular display conditions are satisfied, the status monitor 224 causes the user I/F 13 to display, as a pop-up, a notification screen based on the information acquired from the MFP 3.

The image processing application 225 is a program executable by the PC 1 and configured to transmit a print job or a reading job to the MFP 3 connected via the communication I/F 14. If another image processing device provided by the vendor of the MFP 3 is connected to the PC 1, the other image processing device may also fall within the control scope of the image processing application 225.

The image processing application 225 is a non-resident program configured to receive, when activated in response to a start instruction, a selection of printing or reading. When printing is selected, the image processing application 225 receives a designation of an image or a document to be printed and transmits a print job based on the designated image or document to the MFP 3, thereby causing the MFP 3 to perform printing. When reading is selected, the image processing application 225 transmits a reading job to the MFP 3 and receives image information read by the MFP 3, thereby causing the PC 1 to store the image information.

The monitoring application 226 is a program executable by the PC 1 and configured to periodically check the state of the protection mode and to provide a notification via the user I/F 13 in response to the protection mode being enabled.

The monitoring application 226 is a resident program configured to be automatically activated in response to startup of the OS 21 and to cause, while the OS 21 is running, the PC 1 to monitor the state of the protection mode in the background. For instance, when the protection mode is switched from disabled to enabled, the monitoring application 226 causes the user I/F 13 to display, as a pop-up, a notification screen indicating that the protection mode has been enabled.

For instance, as illustrated in FIG. 1, the PC 1 may be connectable to a server 4 operated by the vendor of the MFP 3. The PC 1 may also be connectable to a store server 5 operated by the vendor of the OS 21. The server 4 and the store server 5 store various programs in a state ready to be supplied. The server 4 and the store server 5 are configured to supply corresponding installers for requested programs in response to requests for the programs from various devices. The server 4 stores the support program 222 prepared by the vendor of the MFP 3 in a state ready to be supplied. The store server 5 stores the support program 222 prepared by the vendor of the MFP 3 in a state ready to be supplied. The support program 222 stored on the server 4 and the support program 222 stored on the store server 5 are substantially the same as the support program 222 included in the integrated installer 22.

### Operations of Integrated Installer

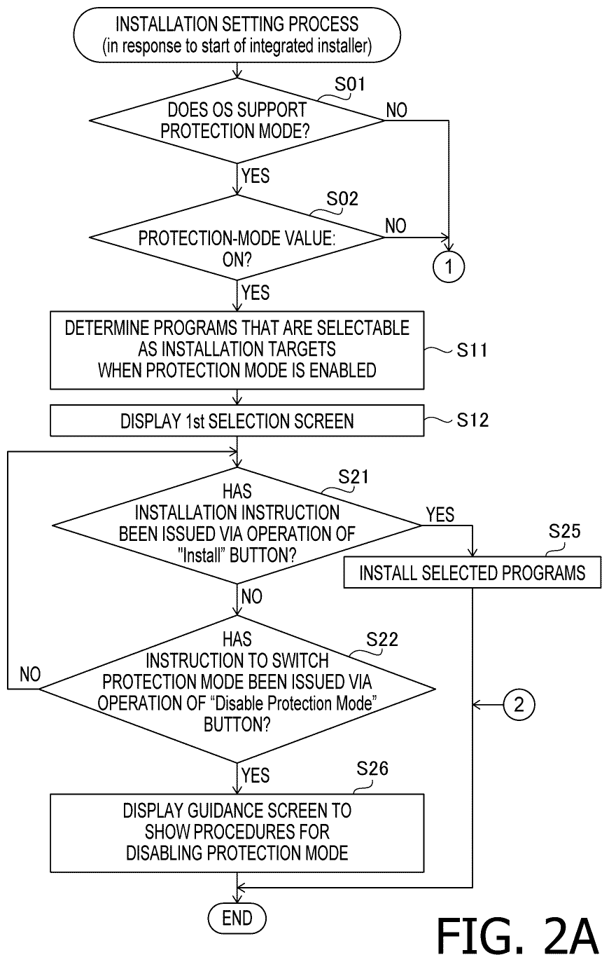

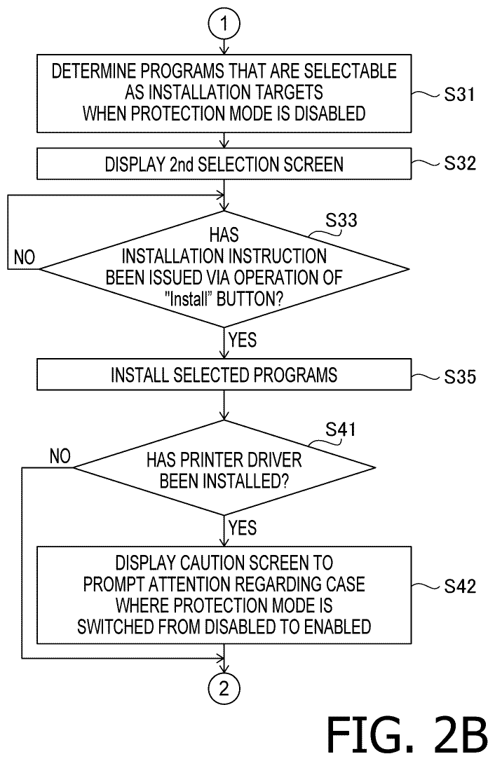

Next, an installation setting process by the integrated installer 22 in the PC 1 of the illustrative embodiment will be described with reference to FIGS. 2A and 2B. The CPU 11 performs the installation setting process in response to receiving a start instruction for the integrated installer 22. In the illustrative embodiment, each process or operation, other than user operations, basically represents processing performed by the CPU 11 according to instructions described in programs such as the integrated installer 22. The processing by the CPU 11 includes control of hardware using APIs of the OS 21. In the present disclosure, operations of each program are described, and details of processing by the OS 21 may be omitted.

In the installation setting process, the CPU 11 first determines whether the OS 21 supports the protection mode (S01). In the illustrative embodiment, the OS 21 is Windows (“Windows” is a registered trademark of Microsoft Corporation), and WPP, which corresponds to the protection mode, is supported in Windows 11, whereas it is not supported in Windows 10 or earlier. Therefore, the CPU 11 acquires a version of the OS 21 and determines, based on the acquired version, whether the protection mode is supported.

In response to determining that the OS 21 supports the protection mode (S01: YES), the CPU 11 determines whether the protection-mode value 212 is ON or OFF (S02). The CPU 11 may acquire the protection-mode value 212 by accessing, for instance, the storage area 210 (see FIG. 1) where the protection-mode value 212 is stored. In another instance, if the OS 21 provides an API for acquiring the protection-mode value 212, the CPU 11 may query the OS 21 via the API, thereby acquiring the protection-mode value 212 based on a response from the OS 21. If the CPU 11 fails to acquire the protection-mode value 212, the CPU 11 may cause the user I/F 13 to display a screen configured to prompt the user to make a selection as to whether the protection mode is enabled and to receive a user selection. In this case, the CPU 11 may determine whether the protection mode is enabled based on the received user selection.

In response to determining that the protection-mode value 212 is ON (S02: YES), the CPU 11 determines programs that are selectable as installation targets when the protection mode is enabled (S11). Specifically, in the illustrative embodiment, the use of the printer driver is restricted when the protection mode is enabled. Therefore, the CPU 11 excludes the printer driver 221 from the choices of installation targets and determines the other programs as the choices. Meanwhile, since the use of a scanner driver is not restricted, the scanner driver 223 is not excluded from the choices of installation targets.

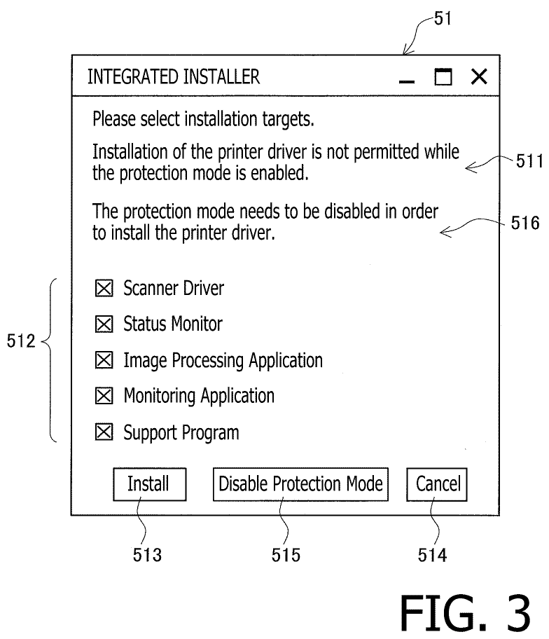

After S11, the CPU 11 causes the user I/F 13 to display a first selection screen configured to receive a user operation for selecting installation targets (S12). For instance, as illustrated in FIG. 3, the CPU 11 causes the user I/F 13 to display a first selection screen 51 that includes messages 511 and 516, a program selection group 512 listing programs that are selectable as installation targets, an “Install” button 513, a “Cancel” button 514, and a “Disable Protection Mode” button 515.

The message 511 includes information indicating that installation of the printer driver is not permitted while the protection mode is enabled. The message 511 allows the user to recognize that installation of the printer driver 221 is not permitted while the protection mode is enabled.

The message 516 includes information indicating that the protection mode needs to be disabled in order to install the printer driver. The message 516 allows the user to recognize that the protection mode needs to be disabled in order to install the printer driver 221.

In the program selection group 512, the programs determined in S11 are presented as choices of installation targets, and a checkbox corresponding to each program is displayed to receive a user selection as to whether to install the corresponding program. If a checkbox is checked, the corresponding program is set as an installation target. If the checkbox is not checked, the program is not set as an installation target. The default state of each checkbox is checked. As described above, installation of the printer driver is not permitted while the protection mode is enabled. Therefore, the printer driver 221 is excluded from the choices of installation targets and is not displayed. That is, on the first selection screen 51, the printer driver 221 is not selectable as an installation target.

On the first selection screen 51, it is sufficient that the printer driver 221 is not selectable. For instance, in the program selection group 512, the printer driver 221 may be displayed in a grayed-out, unselectable state. Displaying the printer driver 221 as unselectable allows the user to recognize that installation of the printer driver 221 is restricted although the printer driver 221 is packaged with the integrated installer 22. On the other hand, as illustrated in FIG. 3, by not displaying the printer driver 221 as one of the choices of installation targets, the number of programs shown in the program selection group 512 is reduced, thereby simplifying the display on the first selection screen 51.

Meanwhile, installation of the support program is permitted even while the protection mode is enabled. Therefore, the support program 222 is displayed as one of the choices of installation targets. In the protection mode of the illustrative embodiment, the use of the printer driver is restricted. However, the use of a scanner driver is not restricted. Therefore, the scanner driver 223 is displayed as one of the choices of installation targets. Further, the status monitor 224 and the image processing application 225 are configured to control a reading device when the scanner driver 223 is installed even if the printer driver 221 is not installed. Therefore, the status monitor 224 and the image processing application 225 are displayed as choices of installation targets. The monitoring application 226 is a program configured to check whether the protection mode is enabled or disabled. The monitoring application 226 is displayed as one of the choices of installation targets regardless of whether the protection mode is enabled or disabled. The support program 222 is installable even while the protection mode is enabled. In addition, the support program 222 serves as a substitute for the printer driver. Therefore, the support program 222 is displayed as one of the choices of installation targets.

The “Install” button 513 is a UI control configured to receive an installation instruction. The “Cancel” button 514 is a UI control configured to receive an instruction to terminate the installation setting process and exit the integrated installer 22. The “Disable Protection Mode” button 515 is a UI control configured to receive an instruction to display procedures for switching the protection mode from enabled to disabled.

After the first selection screen 51 is displayed, the CPU 11 determines whether an installation instruction has been issued via operation of the “Install” button 513 (S21). In response to determining that no installation instruction has been issued (S21: NO), the CPU 11 determines whether an instruction to switch the protection mode has been issued via operation of the “Disable Protection Mode” button 515 (S22). In response to determining that no instruction to switch the protection mode has been issued (S22: NO), the CPU 11 returns to S21 to wait until the “Install” button 513 or the “Disable Protection Mode” button 515 is operated.

In response to determining that an installation instruction has been issued via operation of the “Install” button 513 (S21: YES), the CPU 11 installs the programs currently selected on the first selection screen 51 (S25). At this time, the printer driver 221 is not selectable as an installation target. Therefore, the printer driver 221 is not installed. After S25, the CPU 11 ends the installation setting process.

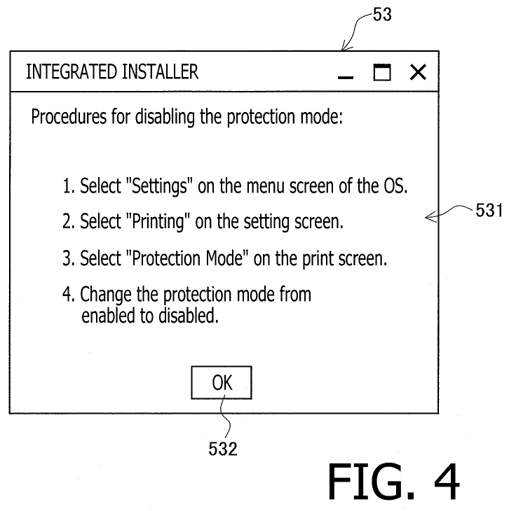

In response to determining that an instruction to switch the protection mode has been issued via operation of the “Disable Protection Mode” button 515 (S22: YES), the CPU 11 causes the user I/F 13 to display a guidance screen configured to show procedures for disabling the protection mode (S26). For instance, as illustrated in FIG. 4, the CPU 11 causes the user I/F 13 to display a guidance screen 53 including a message 531 and an “OK” button 532.

The message 531 includes information indicating operating procedures for switching the protection mode from enabled to disabled. The message 531 allows the user to recognize the procedures for switching the protection mode from enabled to disabled. As a result, a user operation to disable the protection mode may be encouraged. Further, disabling the protection mode removes the restriction on the use of the printer driver 221, thereby prompting the user to use the printer driver 221. When the “OK” button 532 is operated, the CPU 11 causes the user I/F 13 to close the guidance screen 53, completes S26, and ends the installation setting process.

The guidance screen 53 may include, in addition to the message 531, a link to a setting screen that is provided by the OS 21 and configured to receive an instruction to switch the protection mode. In response to an operation on the link, the CPU 11 may request the OS 21 to display the setting screen and may cause the user I/F 13 to display the setting screen. The guidance screen 53 may further include another link. In this case, in response to an operation on the other link, the CPU 11 may start a browser on the PC 1 and may cause the user I/F 13 to display a web page including an explanation regarding the protection mode.

When the protection mode is enabled, the CPU 11 may cause the user I/F 13 to display the first selection screen 51 that does not include the “Disable Protection Mode” button 515 and includes the message 531. That is, the messages 531 and 516 may be displayed together, or may be displayed on different screens at different timings.

Although omitted from the flowcharts of FIGS. 2A and 2B, after the first selection screen 51 is displayed, the CPU 11 receives, in addition to operations on the “Install” button 513 and the “Disable Protection Mode” button 515, an operation on the “Cancel” button 514 as well. In response to receiving an operation on the “Cancel” button 514, the CPU 11 ends the installation setting process without installing any program.

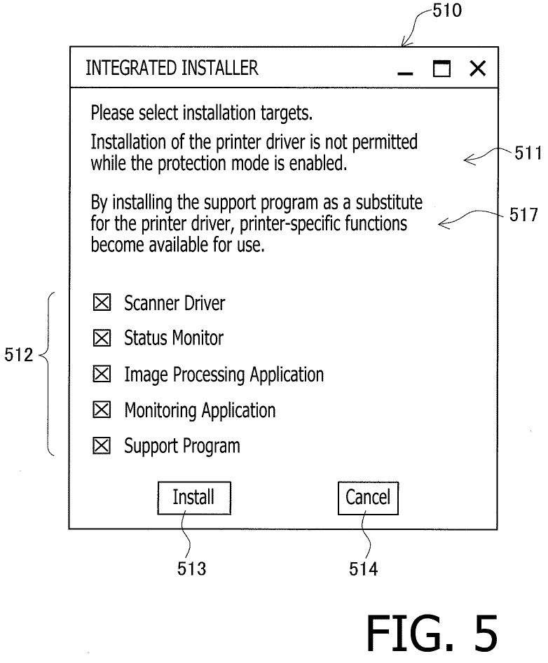

In the illustrative embodiment, the first selection screen 51 that includes the message 516 is displayed on the user I/F 13 when the protection mode is enabled. However, instead of the message 516, the first selection screen 510 including a message 517, as illustrated in FIG. 5, may be displayed on the user I/F 13. The message 517 includes information regarding installation of the support program 222. The message 517 presents the existence of the support program 222 as an installable option, thereby allowing the user to recognize its availability. Since the message 812 prompts the user to install the support program 222 as a substitute for the printer driver 221, the use of the support program 222 is expected to be promoted. The first selection screen 510 illustrated in FIG. 5 does not include information indicating that the protection mode needs to be disabled in order to install the printer driver. Therefore, the first selection screen 510 does not include the “Disable Protection Mode” button 515. However, the first selection screen 510 may include the “Disable Protection Mode” button 515.

When the protection mode is enabled, the first selection screen 51 that includes both the message 516 and the message 517 may be displayed. That is, the message 511, the message 516, and the message 517 may be displayed simultaneously, or may be displayed on different screens at different timings.

On the other hand, in response to determining that the OS 21 does not support the protection mode (S01: NO) or that the protection-mode value 212 is OFF (S02: NO), the CPU 11 determines programs that are selectable as installation targets when the protection mode is disabled (S31). Specifically, in the illustrative embodiment, since the use of the printer driver is not restricted when the protection mode is disabled, the CPU 11 determines, as the choices of installation targets, all programs that are installable by the integrated installer 22, including the printer driver 221.

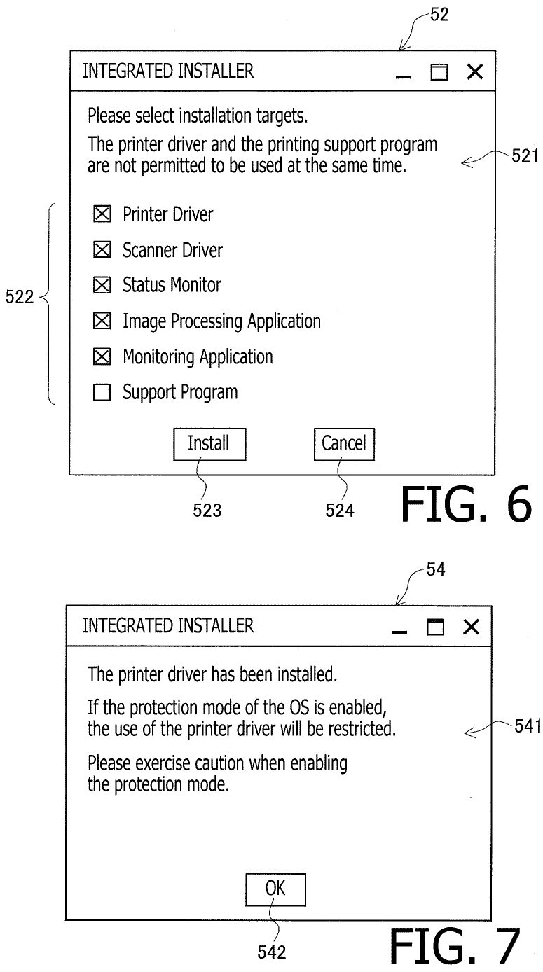

After S31, the CPU 11 causes the user I/F 13 to display a second selection screen configured to receive a user operation for selecting installation targets (S32). For instance, as illustrated in FIG. 6, the CPU 11 causes the user I/F 13 to display a second selection screen 52 including a message 521, a program selection group 522 that lists programs that are selectable as installation targets, an “Install” button 523, and a “Cancel” button 524.

The message 521 includes information indicating that the printer driver and the support program are not permitted to be used at the same time. The message 521 allows the user to recognize that only one of the printer driver 221 or the support program 222 is permitted to be installed. When the protection mode is disabled, the use of the printer driver is not restricted. Therefore, the second selection screen 52 does not include the message 511 that includes information indicating that installation of the printer driver is not permitted.

The program selection group 522 is configured to present, as the choices of installation targets, the programs determined in S31, and to display a checkbox corresponding to each program to receive a user selection as to whether to install the corresponding program. The printer driver 221 and the support program 222 are not allowed to coexist. Therefore, when the checkbox corresponding to one of the programs is checked, the checkbox corresponding to the other program is not permitted to be checked. That is, the second selection screen 52 is configured to receive an exclusive selection of either the printer driver 221 or the support program 222 as an installation target. In the illustrative embodiment, the default state indicates that the checkbox for the printer driver is checked and the checkbox for the support program is not checked. Thus, since the checkbox for the printer driver is checked by default, installation of the printer driver 221 is prioritized over installation of the support program 222. The default state further indicates that the checkboxes for programs other than the printer driver 221 and the support program 222 are checked.

The “Install” button 523 is a UI control configured to receive an installation instruction. The “Cancel” button 524 is a UI control configured to receive an instruction to terminate the installation setting process and exit the integrated installer 22.

After the second selection screen 52 is displayed, the CPU 11 determines whether an installation instruction has been issued via operation of the “Install” button 523 (S33). In response to determining that no installation instruction has been issued via operation of the “Install” button 523 (S33: NO), the CPU 11 waits until the “Install” button 523 is operated.

In response to determining that an installation instruction has been issued via operation of the “Install” button 523 (S33: YES), the CPU 11 installs the programs currently selected on the second selection screen 52 (S35). At this time, since the printer driver 221 and the support program 222 are not allowed to be selected simultaneously as installation targets, the printer driver 221 and the support program 222 are not installed together.

After S35, the CPU 11 determines whether the printer driver 221 has been installed (S41). In response to determining that the printer driver 221 has been installed (S41: YES), the CPU 11 causes the user I/F 13 to display a caution screen configured to prompt attention regarding a case where the protection mode is switched from disabled to enabled (S42). For instance, as illustrated in FIG. 7, the CPU 11 causes the user I/F 13 to display a caution screen 54 including a message 541 and an “OK” button 542.

The message 541 includes information indicating that the use of the printer driver is restricted when the protection mode is enabled. When the protection mode is disabled, the printer driver 221 is installable. However, if the protection mode is enabled after installation of the printer driver 221, the installed printer driver 221 may be deleted by the OS 21. In this case, even if the protection mode is switched back to disabled, the printer driver 221 needs to be reinstalled in order to enable use of the printer driver 221. Therefore, displaying the message 541 allows the user to recognize that, when the protection mode is switched from disabled to enabled, the use of the printer driver 221 is restricted. As a result, it is expected that the user will refrain from enabling the protection mode unnecessarily. In response to an operation on the “OK” button 542, the CPU 11 causes the user I/F 13 to close the caution screen 54 and completes S42. After S42, or in response to determining that the printer driver 221 has not been installed (S41: NO), the CPU 11 ends the installation setting process.

Although omitted from the flowcharts of FIGS. 2A and 2B, after the second selection screen 52 is displayed, the CPU 11 receives, in addition to an operation on the “Install” button 523, an operation on the “Cancel” button 524 as well. In response to receiving an operation on the “Cancel” button 524, the CPU 11 ends the installation setting process without installing any program.

As described above, the integrated installer 22 of the illustrative embodiment determines, prior to installation of the printer driver 221 provided by the vendor of the MFP 3, whether the protection mode for restricting the use of the printer driver is enabled. If the protection mode is not enabled, the integrated installer 22 determines that the printer driver 221 is permitted to be installed. If the protection mode is enabled, the integrated installer 22 determines that the printer driver 221 is not permitted to be installed. Further, in this case, the integrated installer 22 causes the user I/F 13 to display the first selection screen 51, thereby providing a notification that the printer driver is not installable. This allows the user to recognize that the printer driver 221 is not installable. As a result, user operations to install appropriate programs according to the state of the PC 1 are expected.

### Operations of Status Monitor

Next, operations of the status monitor 224 in the PC 1 of the illustrative embodiment will be described. As described above, the status monitor 224 causes the PC 1 to perform periodic communications with the MFP 3 via the communication I/F 14 and to acquire various types of information. In this case, when particular display conditions are satisfied, the status monitor 224 causes the user I/F 13 to display, as a pop-up, a notification screen based on information acquired from the MFP 3. Examples of the particular display conditions may include, but are not limited to, that a particular time has elapsed since the previous display of the notification screen, that information requiring notification has been acquired, and that a user instruction to display the notification screen has been received.

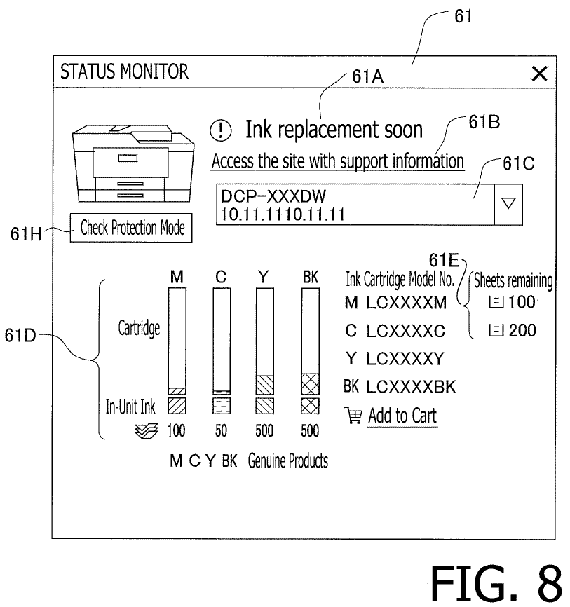

The status monitor 224 causes the PC 1 (more specifically, the user I/F 13) to display, as a pop-up, a notification screen 61, for instance, as illustrated in FIG. 8. When information regarding consumables is acquired from the MFP 3, the notification screen 61 includes information regarding consumables. Specifically, the notification screen 61 includes, for instance, a first character-string display area 61A, a second character-string display area 61B, a model-name display area 61C, an ink-remaining-amount display area 61D, a sheet-remaining-amount display area 61E, and a protection-mode check button 61H. The first character-string display area 61A is configured to display a character string such as “Ink replacement soon.” The second character-string display area 61B is configured to display a character string such as “Access the site with support information,” with a link to the server 4. The model-name display area 61C is configured to display a model name of the MFP 3 selected as a notification target. The ink-remaining-amount display area 61D is configured to display a remaining amount of ink. The sheet-remaining-amount display area 61E is configured to display the number of sheets remaining. The protection-mode check button 61H is a UI control configured to receive an operation for checking the state of the protection mode.

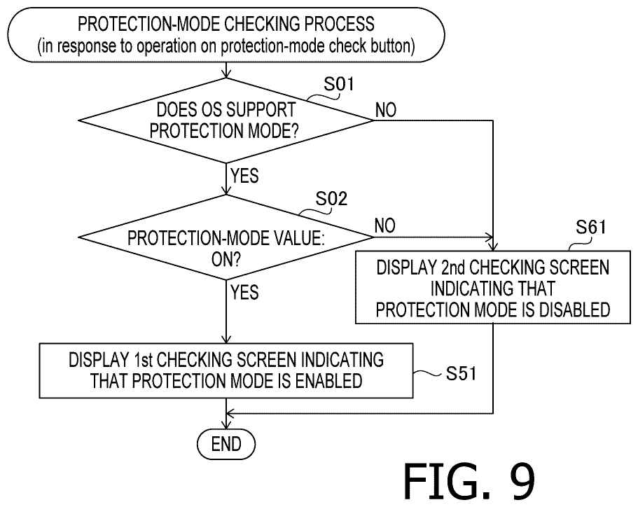

When the protection-mode check button 61H has been operated by the user, the PC 1 executes a protection-mode checking process by the status monitor 224. More specifically, in response to receiving an operation on the protection-mode check button 61H, the CPU 11 of the PC 1 executes the protection-mode checking process. Hereinafter, the protection-mode checking process will be described with reference to FIG. 9. It is noted that processing steps substantially the same as those in the installation setting process illustrated in FIGS. 2A and 2B are denoted by the same reference numerals, and their description may be omitted.

In the protection-mode checking process, the CPU 11 first determines whether the OS 21 supports the protection mode (S01). In response to determining that the OS 21 supports the protection mode (S01: YES), the CPU 11 determines whether the protection-mode value 212 is ON or OFF (S02).

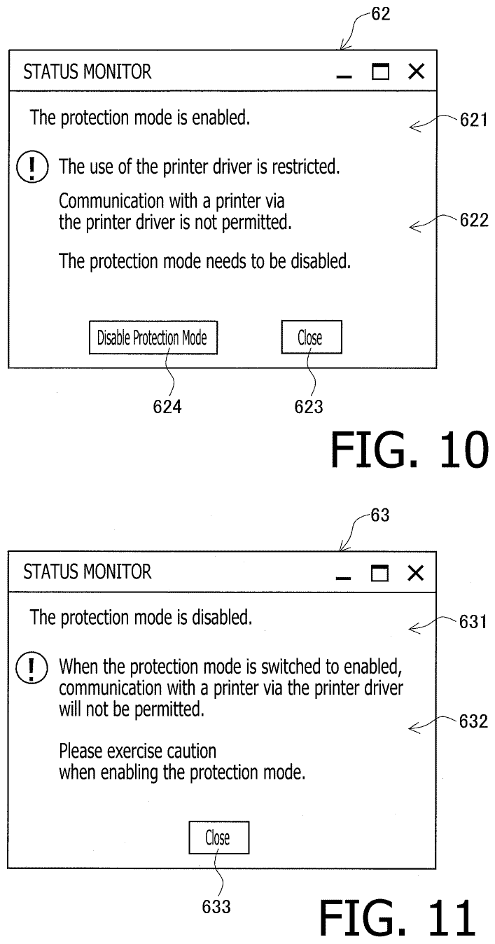

In response to determining that the protection-mode value 212 is ON (S02: YES), the CPU 11 causes the user I/F 13 to display a first checking screen indicating that the protection mode is enabled (S51). For instance, as illustrated in FIG. 10, the CPU 11 causes the user I/F 13 to display a first checking screen 62 including a message 621, a message 622, a “Close” button 623, and a “Disable Protection Mode” button 624.

The message 621 includes information indicating that the protection mode is enabled and that the use of the printer driver is restricted while the protection mode is enabled. The message 621 allows the user to confirm that the protection mode is enabled and further to recognize that the use of the printer driver is restricted. When the use of the printer driver 221 is restricted, the status monitor 224 is not allowed to communicate with the MFP 3 via the printer driver 221. Therefore, in this case, the message 621 may further include information indicating that the PC 1 is not allowed to communicate with the MFP 3 via the printer driver 221. The message 621 may further include more specific information indicating that functions affected by the communication failure between the PC 1 and the MFP 3 via the printer driver 221—such as status display and consumables display—are not available.

The message 622 includes information indicating that, in order to use the printer driver, the protection mode needs to be disabled. The message 622 allows the user to recognize that, in order to use the printer driver 221, the protection mode needs to be disabled.

After the first checking screen 62 is displayed, the CPU 11 waits until the “Close” button 623 or the “Disable Protection Mode” button 624 is operated. In response to an operation on the “Disable Protection Mode” button 624, the CPU 11 causes the user I/F 13 to display the guidance screen 53 illustrated in FIG. 4, in substantially the same manner as in response to an operation on the “Disable Protection Mode” button 515 on the first selection screen 51 illustrated in FIG. 3. That is, the CPU 11 performs substantially the same processing as in S26 of the installation setting process. In response to an operation on the “Close” button 623, the CPU 11 causes the user I/F 13 to close the first checking screen 62 and ends the protection-mode checking process.

On the other hand, in response to determining that the OS 21 does not support the protection mode (S01: NO) or that the protection-mode value 212 is OFF (S02: NO), the CPU 11 causes the user I/F 13 to display a second checking screen indicating that the protection mode is disabled (S61). For instance, as illustrated in FIG. 11, the CPU 11 causes the user I/F 13 to display a second checking screen 63 including a message 631, a message 632, and a “Close” button 633.

The message 631 includes information indicating that the protection mode is disabled. The message 631 allows the user to confirm that the protection mode is disabled.

The message 632 includes information indicating that, if the protection mode is enabled, execution of functions of the status monitor that use the printer driver is restricted. When the protection mode is disabled, the status monitor 224 is allowed to use the printer driver 221. However, if the protection mode becomes enabled, the printer driver 221 may be deleted by the OS 21. In this case, even if the protection mode is switched back to disabled, the printer driver 221 needs to be reinstalled in order to use the printer driver 221. Therefore, displaying the message 632 allows the user to recognize that, when the protection mode is switched from disabled to enabled, the use of the printer driver 221 is restricted. As a result, it is expected that the user will refrain from enabling the protection mode unnecessarily.

After the second checking screen 63 is displayed, the CPU 11 waits until the “Close” button 633 is operated. In response to an operation on the “Close” button 633, the CPU 11 causes the user I/F 13 to close the second checking screen 63 and ends the protection-mode checking process.

In response to an operation on the protection-mode check button 61H on the notification screen 61, the status monitor 224 causes the user I/F 13 to display either the first checking screen 62 or the second checking screen 63 separately from the notification screen 61. In this case, the status monitor 224 includes a message based on the state of the protection mode in the separately displayed screen. However, the status monitor 224 may display neither the first checking screen 62 nor the second checking screen 63 separately from the notification screen 61. In such a case, the status monitor 224 may include a message based on the state of the protection mode in the notification screen 61.

Further, user operations for causing the PC 1 to execute the protection-mode checking process by the status monitor 224 are not limited to operation of the protection-mode check button 61H. For instance, when a menu for providing an instruction to check whether the protection mode is enabled is available, the PC 1 may execute the protection-mode checking process by the status monitor 224 in response to a user operation on the menu.

As described above, in the illustrative embodiment, at the time when the protection-mode check button 61H has been operated by the user, the status monitor 224 determines whether the protection mode for restricting the use of the printer driver is enabled. If the protection mode is enabled, the status monitor 224 causes the user I/F 13 to display the first checking screen 62, thereby providing a notification that the use of the printer driver is restricted. This allows the user to recognize, at any timing desired by the user, whether the user is permitted to use the printer driver 221.

### Operations of Image Processing Application

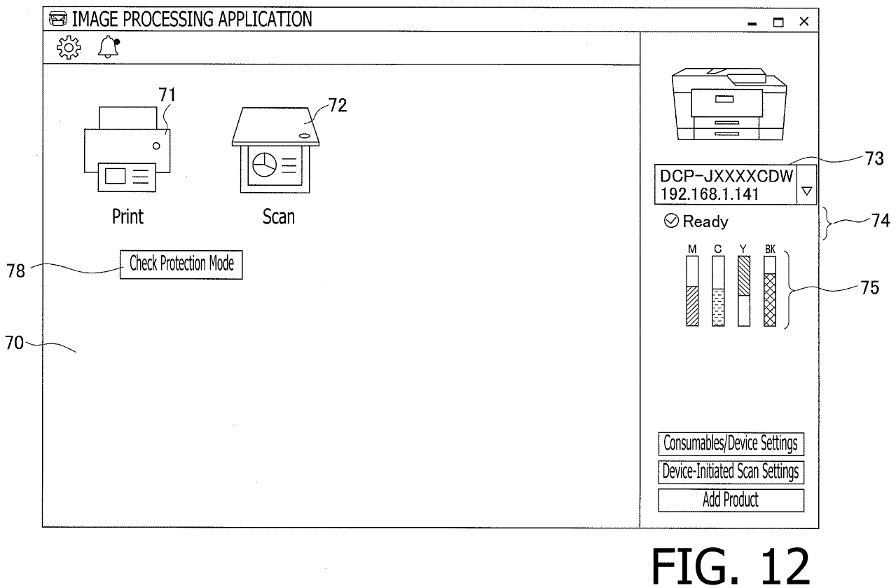

Next, operations of the image processing application 225 in the PC 1 of the illustrative embodiment will be described. When started, the image processing application 225 causes the PC 1 to display a home screen 70, for instance, as illustrated in FIG. 12.

On the home screen 70, icons (e.g., a print icon 71 and a scan icon 72) corresponding to functions available on the MFP 3, which is the selected device, are displayed. The home screen 70 further includes a controlled-model-name display area 73, a status-information display area 74, a remaining-amount display area 75, and a protection-mode check button 78. The controlled-model-name display area 73 is configured to display a name of the selected device. The status-information display area 74 is configured to display status information of the selected device. The remaining-amount display area 75 is configured to display remaining amounts of consumables of the selected device. The protection-mode check button 78 is a UI control configured to receive an operation for checking the state of the protection mode.

In response to a user operation on the protection-mode check button 78, the image processing application 225 causes, in substantially the same manner as the status monitor 224, the PC 1 to determine whether the protection mode is enabled and to provide a notification based on a determination result. However, the image processing application 225 causes the PC 1 (more specifically, the user I/F 13) to provide the notification based on the determination result by including it in the home screen 70. In this respect, the image processing application 225 differs from the status monitor 224, which causes the user I/F 13 to display either the first checking screen 62 or the second checking screen 63 separately from the notification screen 61.

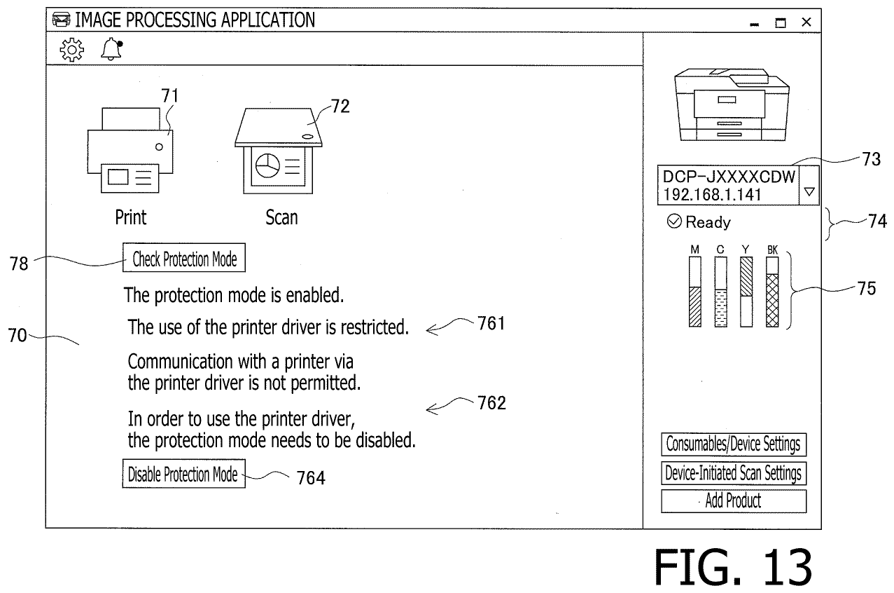

For instance, as illustrated in FIG. 13, if the protection mode is enabled, the image processing application 225 adds, to the home screen 70, a message 761, a message 762, and a “Disable Protection Mode” button 764. The message 761 includes information indicating that the protection mode is enabled and that the use of the printer driver is restricted while the protection mode is enabled.

The message 761 may be the same as the message 621 included in the first checking screen 62 displayed by the status monitor 224. The message 762 includes information indicating that, in order to use the printer driver, the protection mode needs to be disabled. The message 762 may be the same as the message 622 included in the first checking screen 62 displayed by the status monitor 224.

In response to an operation on the “Disable Protection Mode” button 764, the image processing application 225 causes the user I/F 13 to display the guidance screen 53 illustrated in FIG. 4, in substantially the same manner as in response to an operation on the “Disable Protection Mode” button 624 on the first checking screen 62 illustrated in FIG. 10. That is, the image processing application 225 causes the PC 1 to perform substantially the same processing as in S26 of the installation setting process. Instead of displaying the guidance screen 53, the message 531 included in the guidance screen 53 may be included in the home screen 70.

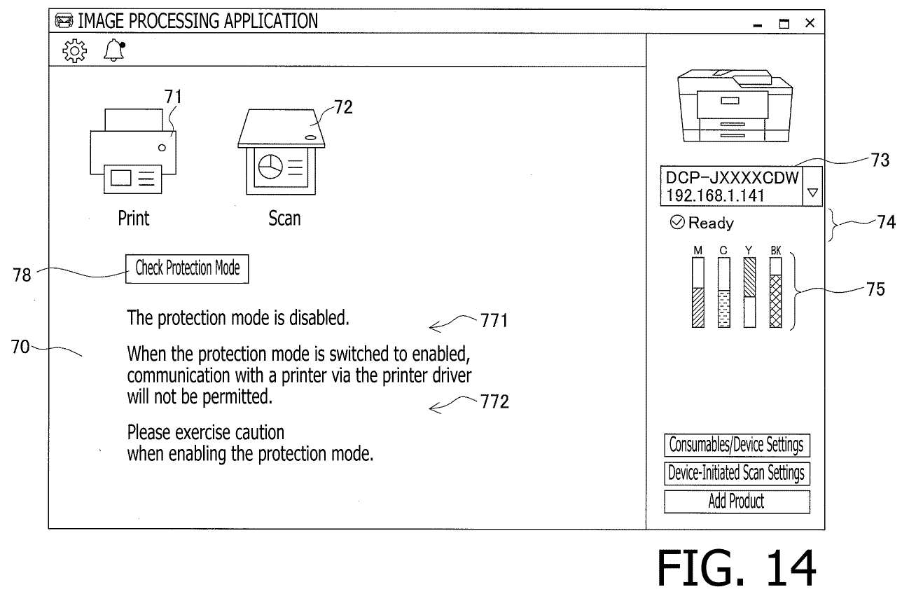

If the protection mode is disabled, the image processing application 225 adds, to the home screen 70, a message 771 and a message 772, for instance, as illustrated in FIG. 14. The message 771 includes information indicating that the protection mode is disabled. The message 771 may be the same as the message 631 included in the second checking screen 63 displayed by the status monitor 224. The message 772 includes information indicating that, if the protection mode is enabled, execution of functions of the status monitor that use the printer driver is restricted. The message 772 may be the same as the message 632 included in the second checking screen 63 displayed by the status monitor 224.

In response to an operation on the protection-mode check button 78 on the home screen 70, the image processing application 225 adds, to the home screen 70, a message based on the state of the protection mode. However, instead of adding the message to the home screen 70, the image processing application 225 may display a separate screen and include the message based on the state of the protection mode in the separate screen.

Further, user operations for causing the image processing application 225 to add a message based on the state of the protection mode to the home screen 70 are not limited to operation of the protection-mode check button 78. For instance, when a menu for providing an instruction to check whether the protection mode is enabled is available, the image processing application 225 may cause the user I/F 13 to display a message based on the state of the protection mode in response to a user operation on the menu.

As described above, in the illustrative embodiment, at the time when the protection-mode check button 78 has been operated by the user, the image processing application 225 determines whether the protection mode for restricting the use of the printer driver is enabled. If the protection mode is enabled, the image processing application 225 adds, to the home screen 70, a message 762 notifying that the use of the printer driver is restricted. This allows the user to recognize, at any timing desired by the user, whether the user is permitted to use the printer driver 221.

### Operations of Monitoring Application

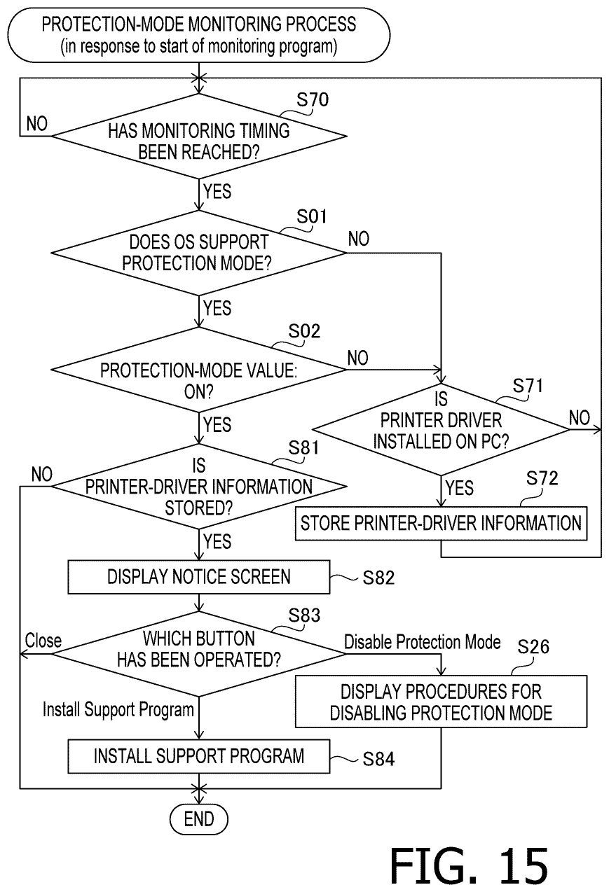

Next, a protection-mode monitoring process by the monitoring application 226 in the PC 1 of the illustrative embodiment will be described with reference to FIG. 15. The CPU 11 of the PC 1 executes the protection-mode monitoring process in response to receiving a start instruction for the monitoring application 226. It is noted that processing steps substantially the same as those in the installation setting process illustrated in FIGS. 2A and 2B are denoted by the same reference numerals, and description thereof may be omitted.

In the protection-mode monitoring process, the CPU 11 first determines whether a monitoring timing has been reached (S70). In the monitoring application 226, a monitoring interval is set for periodically executing the protection-mode monitoring process. The monitoring timing is reached when the monitoring interval has elapsed from startup or from a previous execution of the protection-mode monitoring process. In response to determining that the monitoring timing has not been reached (S70: NO), the CPU 11 waits until the monitoring timing is reached.

In response to determining that the monitoring timing has been reached (S70: YES), the CPU 11 determines whether the OS 21 supports the protection mode (S01). In response to determining that the OS 21 supports the protection mode (S01: YES), the CPU 11 determines whether the protection-mode value 212 is ON or OFF (S02).

In response to determining that the OS 21 does not support the protection mode (S01: NO) or that the protection-mode value 212 is OFF (S02: NO), the CPU 11 determines whether the printer driver 221 is installed on the PC 1 (S71). In response to determining that the printer driver 221 is installed on the PC 1 (S71: YES), the CPU 11 stores printer-driver information indicating the printer driver 221 stored in the PC 1 in a region of the memory 12 different from a region for the printer driver 221 (S72). The printer-driver information may include, but is not limited to, a version of the printer driver 221. After S72, or in response to determining that the printer driver 221 is not installed on the PC 1 (S71: NO), the CPU 11 proceeds to S70 and waits again until the monitoring timing is reached.

In response to determining that the protection-mode value 212 is ON (S02: YES), the CPU 11 determines whether the printer-driver information is stored in the memory 12 (S81). The printer-driver information is information stored in S72. When the protection mode becomes enabled, the printer driver 221 is deleted by the OS 21. However, the printer-driver information stored in S72 is stored by the monitoring application 226 and is not deleted by the OS 21 even if the printer driver 221 is deleted in response to the protection mode being enabled. Further, when executing the protection-mode monitoring process with the protection mode enabled from the beginning, the CPU 11 does not execute S72. Therefore, the printer-driver information is not stored in the memory 12. That is, the presence of the printer-driver information on the PC 1 means that the printer driver 221 was present on the PC 1 prior to the protection mode becoming enabled and that the printer driver 221 has been deleted by the OS 21 in response to the protection mode becoming enabled.

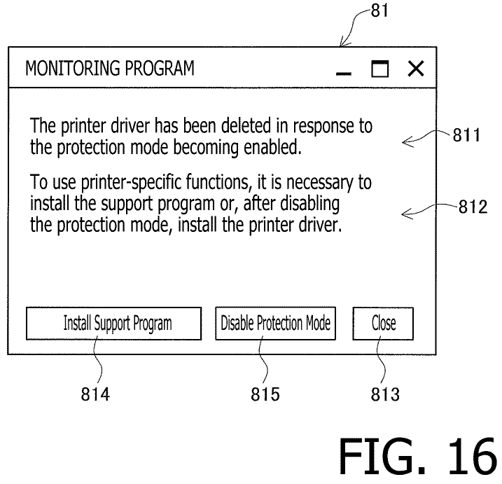

Accordingly, in response to determining that the printer-driver information is stored in the memory 12 (S81: YES), the CPU 11 causes the user I/F 13 to display a notice screen indicating that the printer driver 221 has been deleted (S82). For instance, as illustrated in FIG. 16, the CPU 11 causes the user I/F 13 to display a notice screen 81 including a message 811, a message 812, a “Close” button 813, an “Install Support Program” button 814, and a “Disable Protection Mode” button 815.

The message 811 includes information indicating that the printer driver has been deleted in response to the protection mode becoming enabled. The message 811 allows the user to recognize that the printer driver 221 has been deleted. Further, since the printer driver 221 has been deleted, the user may also recognize that the user is not permitted to use the printer driver 221 (i.e., that the use of the printer driver 221 is restricted).

The message 812 includes information regarding installation of the support program 222 and information indicating that, in order to install the printer driver, the protection mode needs to be disabled. Further, the message 812 presents the existence of the support program 222 as an installable option, thereby allowing the user to recognize its availability. Since the message 812 prompts the user to install the support program 222 as a substitute for the printer driver 221, the use of the support program 222 is expected to be promoted. In addition, the message 812 allows the user to recognize that, in order to install the printer driver 221, the protection mode needs to be disabled. Therefore, a user operation to disable the protection mode is expected.

The “Install Support Program” button 814 is a UI control configured to receive an instruction to install the support program 222. The “Disable Protection Mode” button 815 is a UI control configured to receive an instruction to display procedures for switching the protection mode from enabled to disabled. The “Close” button 813 is a UI control configured to receive an instruction to close the notice screen 81 without installing the support program 222.

After displaying the notice screen 81, the CPU 11 determines which button has been operated among the “Install Support Program” button 814, the “Disable Protection Mode” button 815, and the “Close” button 813 (S83).

In response to an operation on the “Install Support Program” button 814 (S83: Install Support Program), the CPU 11 installs the support program 222 on the PC 1 (S84). For instance, the CPU 11 may access the server 4 or the store server 5 to download the support program 222, thereby installing the support program 222. In another instance, when the integrated installer 22 is stored on the PC 1, the CPU 11 may start the integrated installer 22, thereby installing the support program 222.

In response to an operation on the “Disable Protection Mode” button 815 (S83: Disable Protection Mode), the CPU 11 causes the user I/F 13 to display a guidance screen presenting procedures for disabling the protection mode (S26). Displaying the guidance screen allows the user to understand the procedures for disabling the protection mode. Accordingly, a user operation to disable the protection mode is expected. The CPU 11 may cause the user I/F 13 to display the guidance screen 53 including the message 531, for instance, as illustrated in FIG. 4.

When the OS 21 provides an API for switching the protection mode from enabled to disabled—that is, an API for changing the protection-mode value 212 from ON to OFF—the CPU 11 may proceed to S26 in response to an operation on the “Disable Protection Mode” button 515 and, instead of displaying the guidance screen 53, provide an instruction to the OS 21 via the API, thereby automatically switching the protection mode from enabled to disabled.

After S84 or after S26, or in response to an operation on the “Close” button 813 (S83: Close), the CPU 11 ends the protection-mode monitoring process. As a result, monitoring of the protection mode by the monitoring application 226 ends. When ending the protection-mode monitoring process, the CPU 11 may stop periodic determinations while keeping the monitoring application 226 resident—i.e., may inhibit the monitoring timing from being reached—or may terminate the monitoring application 226.

When the printer-driver information is not stored in the memory 12 (S81: NO), the printer driver 221 has not been used prior to the protection mode being enabled, and the need for notifications regarding the printer driver is low. Rather, a display regarding the printer driver may confuse the user. Therefore, the CPU 11 ends the protection-mode monitoring process without executing S82 to display the notice screen 81.

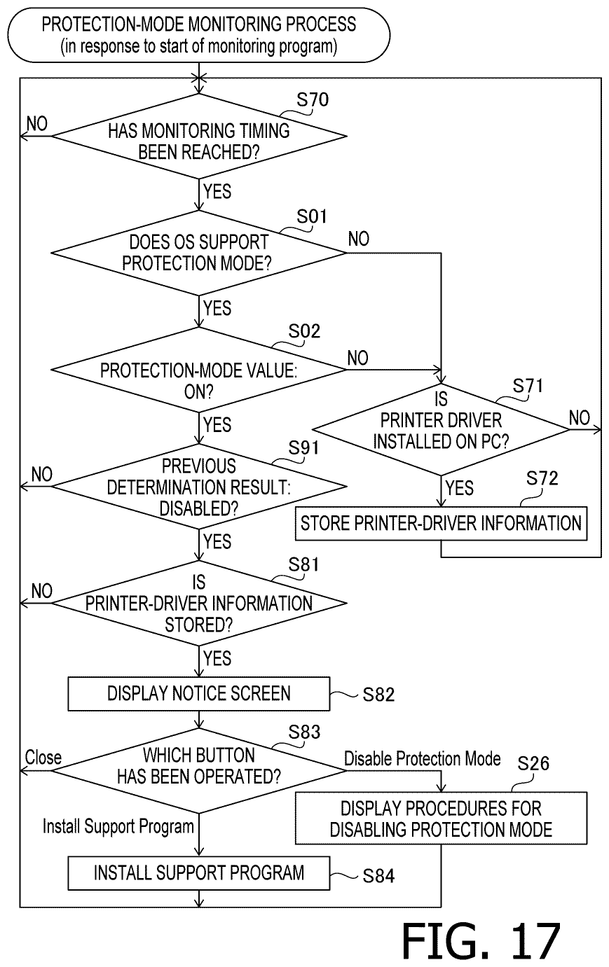

In the protection-mode monitoring process illustrated in FIG. 15, in response to determining that the protection mode has become enabled, the CPU 11 causes the user I/F 13 to display the notice screen 81 and then ends the protection-mode monitoring process. However, the CPU 11 may continue to monitor the protection mode without ending the protection-mode monitoring process. In this case, as illustrated in FIG. 17, after determining that the protection mode has become enabled, the CPU 11 proceeds to S70 without ending the protection-mode monitoring process, and waits again until the monitoring timing is reached. Further, after determining that the protection-mode value 212 is ON (S02: YES) and before determining whether the printer-driver information is stored in the memory 12 (S81), the CPU 11 determines whether the previous determination result was “disabled”—that is, whether the CPU 11 determined, in the previous execution of S02, that the protection mode was disabled (S91). In response to determining that the previous determination result was “disabled” (S91: YES)—that is, if the protection mode has changed from disabled to enabled—the CPU 11 proceeds to S81. In response to determining that the previous determination result was “enabled” (S91: NO)—that is, if the protection mode remains enabled—the CPU 11 does not proceed to S81 but proceeds to S70 to wait again until the monitoring timing is reached. This inhibits the notice screen 81 from being repeatedly displayed while the protection mode remains enabled.

As in the protection-mode monitoring process illustrated in FIG. 17, even after detecting that the protection mode has changed from disabled to enabled, the PC 1 may keep the monitoring application 226 running and continue to monitor whether the protection mode changes from disabled to enabled. This allows the PC 1 to display the notice screen 81 even when the protection mode subsequently changes from disabled to enabled. On the other hand, as in the protection-mode monitoring process illustrated in FIG. 15, when the PC 1 ends the monitoring application 226 in response to detecting that the protection mode has changed from disabled to enabled, the PC 1 no longer periodically monitors whether the protection mode changes from disabled to enabled, thereby reducing the processing load on the PC 1.

When the protection mode has changed from disabled to enabled, the PC 1 may display a notice screen 81 that includes the message 531 and does not include the “Disable Protection Mode” button 815. That is, the message 531 may be displayed together with at least one of the message 811 or the message 812, or may be displayed on a different screen at a different timing.

As described above, in the illustrative embodiment, the monitoring application 226 repeatedly determines the state of the protection mode for restricting the use of the printer driver. Then, in response to determining that the protection mode has changed from disabled to enabled, the monitoring application 226 causes the user I/F 13 to display the notice screen 81, thereby notifying the user that the use of the printer driver is not permitted. This allows the user to recognize, immediately after the protection mode changes from disabled to enabled, that the use of the printer driver is not permitted and that applications using the printer driver are affected.

The monitoring application 226 may be a non-resident program rather than a resident program. In this case, the monitoring application 226 may be started at any timing desired by the user, and instead of executing the protection-mode monitoring process, the CPU 11 may cause the user I/F 13 to display a home screen that includes a protection-mode check button. In this case, in response to an operation on the protection-mode check button included in the home screen, the CPU 11 may execute the protection-mode checking process illustrated in FIG. 9. Accordingly, the monitoring application 226 may be used as a tool for checking whether the protection mode is enabled.

As described above, the integrated installer 22, the status monitor 224, the image processing application 225, and the monitoring application 226 of the illustrative embodiment determine whether the protection mode set by the OS 21 is enabled and, when the protection mode is enabled, cause the user I/F 13 to display information regarding a restriction on the use of the printer driver. This allows a user viewing the information to recognize that the use of the printer driver is restricted.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, the display configuration of each screen is merely an example and is not limited to the illustrated case. The shapes and arrangements of various buttons and the wording of messages may be of any kind. In addition, although examples have been shown in which various messages are displayed within the respective screens, the messages may be displayed in a window separate from the screen or as a pop-up.

In the aforementioned illustrative embodiment, the image processing device connected to the PC 1 is an MFP having both the printing function and the reading function. However, the image processing device may be a printing device that does not have the reading function, or a reading device that does not have the printing function. The image processing device connected to the PC 1 may also be, for instance, a copying machine or a facsimile machine.

In the aforementioned illustrative embodiment, the integrated installer 22 has been described as including the support program 222. However, the integrated installer 22 may not include the support program 222. In that case, if the PC 1 is not allowed to access the store server 5 or the server 4 of the vendor of the MFP 3, the user may obtain the support program 222 by, for instance, requesting an administrator to change settings to enable the PC 1 to access the store server 5 or the server 4. In addition, both an integrated installer 22 that includes the support program 222 and an integrated installer 22 that does not include the support program 222 may be provided.

Further, in the aforementioned illustrative embodiment, the OS 21 has been described as Windows (“Windows” is a registered trademark of Microsoft Corporation). However, examples of the OS 21 may include macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

In the aforementioned illustrative embodiment, when the protection mode is enabled, the use of the printer driver is restricted while the use of the scanner driver is not restricted. However, the use of the scanner driver may also be restricted. In such a case, messages displayed in response to determining that the protection mode is enabled may further include information indicating that the use of the scanner driver is restricted. For instance, the messages 511 and 621 may include information indicating that the printer driver and the scanner driver are not installable while the protection mode is enabled. The message 516 may include information indicating that, in order to install at least one of the printer driver or the scanner driver, the protection mode needs to be disabled. The messages 622 and 812 may include information indicating that, in order to use at least one of the printer driver or the scanner driver, the protection mode needs to be disabled. The messages 541 and 632 may include information regarding a restriction on the use of the printer driver and the scanner driver when the protection mode is enabled. The message 811 may include information indicating that the printer driver and the scanner driver have been deleted in response to the protection mode becoming enabled.

Moreover, in any of the flowcharts described in the aforementioned illustrative embodiment, a plurality of processes in a plurality of steps may be executed in an arbitrarily changed order or in parallel, as long as no contradictions arise in the processing content.

Furthermore, the processes described in the aforementioned illustrative embodiment may be executed by one or more CPUs, one or more hardware elements such as ASICs, or a combination of at least two of them. In addition, the processes described in the illustrative embodiment may be realized in various forms, such as by a non-transitory computer-readable storage medium storing programs for executing the processes, and by a method.

The following provides examples of associations between elements set forth in the aforementioned illustrative embodiment(s) and modification(s), and elements claimed according to aspects of the present disclosure. For instance, the PC 1 may be an example of an “information processing device” according to aspects of the present disclosure. The controller 10 may be an example of a “controller” according to aspects of the present disclosure. The CPU 11 may be an example of a “processor” according to aspects of the present disclosure. The user I/F 13 may be an example of a “user interface” according to aspects of the present disclosure. The memory 12 may be an example of a “non-transitory computer-readable storage medium” according to aspects of the present disclosure. The OS 21 may be an example of an “operating system (OS)” according to aspects of the present disclosure. The integrated installer 22 may be an example of “computer-readable instructions” according to aspects of the present disclosure. The support program 222 may be an example of a “support program” according to aspects of the present disclosure. The printer driver 221 may be an example of a “device driver” according to aspects of the present disclosure. The MFP 3 may be an example of an “image processing device” according to aspects of the present disclosure. The protection-mode setting may be an example of an “OS setting” according to aspects of the present disclosure. The protection-mode value 212 may be an example of “setting information” according to aspects of the present disclosure.

What is claimed is:

1. A non-transitory computer-readable storage medium storing computer-readable instructions that are executable by a processor of an information processing device comprising a user interface and an operating system (OS), the computer-readable instructions being configured to, when executed by the processor, cause the information processing device to:
determine whether an OS setting is enabled, the OS setting being a setting of the OS for restricting use of a device driver provided by a vendor of an image processing device; and
in response to determining that the OS setting is enabled, cause the user interface to display restriction information regarding a restriction on the use of the device driver.

2. The non-transitory computer-readable storage medium according to claim 1,
wherein the computer-readable instructions are further configured to, when executed by the processor, cause the information processing device to, in response to determining that the OS setting is enabled, cause the user interface to display procedure information indicating operation procedures for disabling the OS setting.

3. The non-transitory computer-readable storage medium according to claim 1,
wherein the computer-readable instructions are further configured to, when executed by the processor, cause the information processing device to, if the OS is a version that does not support the OS setting, cause the user interface not to display the restriction information.

4. The non-transitory computer-readable storage medium according to claim 1,
wherein the computer-readable instructions are further configured to, when executed by the processor, cause the information processing device to query the OS as to whether the OS setting is enabled and, based on a response from the OS, determine whether the OS setting is enabled.

5. The non-transitory computer-readable storage medium according to claim 1,
wherein the information processing device stores, in a particular storage area managed by the OS, setting information indicating whether the OS setting is enabled, and
wherein the computer-readable instructions are further configured to, when executed by the processor, cause the information processing device to read the setting information from the particular storage area and, based on the read setting information, determine whether the OS setting is enabled.

6. The non-transitory computer-readable storage medium according to claim 1,
wherein the image processing device has a first function and a second function relating to image processing,
wherein the information processing device is configured to, when the OS setting is enabled, restrict use of a first device driver corresponding to the first function and not restrict use of a second device driver corresponding to the second function, and
wherein the computer-readable instructions are further configured to, when executed by the processor, cause the information processing device to, in response to determining that the OS setting is enabled, cause the user interface to display restriction information regarding a restriction on the use of the first device driver.

7. The non-transitory computer-readable storage medium according to claim 6,
wherein the first function is a printing function, and the second function is a reading function, and
wherein the computer-readable instructions are further configured to, when executed by the processor, cause the information processing device to, in response to determining that the OS setting is enabled, cause the user interface to display restriction information regarding a restriction on use of a printer driver that is the first device driver corresponding to the first function.

8. The non-transitory computer-readable storage medium according to claim 1,
wherein the device driver is a printer driver for causing the image processing device having a printing function to perform printing.

9. The non-transitory computer-readable storage medium according to claim 1,
wherein the computer-readable instructions are further configured to, when executed by the processor, cause the information processing device to:
install, on the information processing device, the device driver provided by the vendor of the image processing device;
prior to installing the device driver, determine whether the OS setting is enabled;
in response to determining that the OS setting is not enabled, receive a selection as to whether to install the device driver, and determine whether to install the device driver based on the received selection; and
in response to determining that the OS setting is enabled, cause the user interface to display the restriction information without installing the device driver.

10. The non-transitory computer-readable storage medium according to claim 9,
wherein the computer-readable instructions are further configured to, when executed by the processor, cause the information processing device to:
cause the user interface to display a program selection screen configured to receive a selection of one or more installation targets from among a plurality of programs including the device driver, receive the selection via the program selection screen, and install the selected one or more installation targets;
in response to determining that the OS setting is not enabled, cause the user interface to display the program selection screen on which the device driver is selectable as an installation target, and determine whether to install the device driver based on whether the device driver is selected on the program selection screen; and
in response to determining that the OS setting is enabled, cause the user interface to display, as the restriction information, the program selection screen on which the device driver is unselectable.

11. The non-transitory computer-readable storage medium according to claim 9,
wherein the computer-readable instructions are further configured to, when executed by the processor, cause the information processing device to:
cause the user interface to display a program selection screen configured to receive a selection of one or more installation targets from among a plurality of programs including the device driver, receive the selection via the program selection screen, and install the selected one or more installation targets;
in response to determining that the OS setting is not enabled, cause the user interface to display the program selection screen on which the device driver is included among selectable items for installation, and determine whether to install the device driver based on whether the device driver is selected on the program selection screen; and
in response to determining that the OS setting is enabled, cause the user interface to display, as the restriction information, the program selection screen on which the device driver is not included among the selectable items for installation.

12. The non-transitory computer-readable storage medium according to claim 9,
wherein the computer-readable instructions are further configured to, when executed by the processor, cause the information processing device to, in response to determining that the OS setting is not enabled, cause the user interface to display caution information indicating that, if the OS setting is enabled, the use of the device driver is restricted.

13. The non-transitory computer-readable storage medium according to claim 9,
wherein the computer-readable instructions are further configured to, when executed by the processor, cause the information processing device to, in response to determining that the OS setting is enabled, cause the user interface to display guidance information regarding installation of a support program configured to support an OS standard printing program, wherein use of the support program is not restricted even when the OS setting is enabled.

14. The non-transitory computer-readable storage medium according to claim 9,
wherein the restriction information includes:
information indicating that the device driver is not installable while the OS setting is enabled; and
information indicating that the OS setting needs to be disabled in order to install the device driver.

15. The non-transitory computer-readable storage medium according to claim 1,
wherein the computer-readable instructions are further configured to, when executed by the processor, cause the information processing device to:
cause the user interface to display an operation screen configured to receive a particular user operation;
in response to receiving the particular user operation via the operation screen, determine whether the OS setting is enabled; and
in response to determining that the OS setting is enabled, cause the user interface to display the restriction information.

16. The non-transitory computer-readable storage medium according to claim 15,
wherein the computer-readable instructions are further configured to, when executed by the processor, cause the information processing device to:
using the device driver provided by the vendor of the image processing device, acquire device information from the image processing device connected to the information processing device, and execute a specific process based on the acquired device information; and
in response to determining that the OS setting is enabled, cause the user interface to display the restriction information including information indicating that the specific process is not executable.

17. The non-transitory computer-readable storage medium according to claim 16,
wherein the specific process comprises causing the user interface to display notification information based on the acquired device information.

18. The non-transitory computer-readable storage medium according to claim 16,
wherein the specific process comprises transmitting to the image processing device a job for executing image processing based on the acquired device information, thereby causing the image processing device to execute the job.

19. The non-transitory computer-readable storage medium according to claim 1,
wherein the computer-readable instructions are further configured to, when executed by the processor, cause the information processing device to:
repeatedly determine whether the OS setting is enabled; and
in response to determining that the OS setting has been switched from disabled to enabled, cause the user interface to display the restriction information.

20. The non-transitory computer-readable storage medium according to claim 19,
wherein the computer-readable instructions are further configured to, when executed by the processor, cause the information processing device to:
in response to determining that the OS setting has been switched from disabled to enabled, determine whether the device driver has ever been installed on the information processing device;
determine whether to display the restriction information based on whether the device driver has ever been installed on the information processing device, wherein the information processing device causes the user interface to display the restriction information if the device driver has ever been installed, and causes the user interface not to display the restriction information if the device driver has never been installed.

21. The non-transitory computer-readable storage medium according to claim 20,
wherein the computer-readable instructions are further configured to, when executed by the processor, cause the information processing device to perform processing to reinstall the device driver in response to determining that the OS setting has been switched from disabled to enabled and that the device driver has ever been installed.

22. The non-transitory computer-readable storage medium according to claim 19,
wherein the computer-readable instructions are further configured to, when executed by the processor, cause the information processing device to, in response to determining that the OS setting has been switched from disabled to enabled, cause the user interface to display guidance information regarding installation of a support program configured to support an OS standard printing program.

23. The non-transitory computer-readable storage medium according to claim 19,
wherein the computer-readable instructions are further configured to, when executed by the processor, cause the information processing device to, in response to determining that the OS setting has been switched from disabled to enabled, cause the user interface to display the restriction information, and cease further repetition of determining whether the OS setting is enabled.

24. The non-transitory computer-readable storage medium according to claim 19,
wherein the computer-readable instructions are further configured to, when executed by the processor, cause the information processing device to:
in response to determining that the OS setting has been switched from disabled to enabled, continue repeatedly determining whether the OS setting is enabled, even after causing the user interface to display the restriction information; and
in response to a subsequent determination that the OS setting has been switched from disabled to enabled, cause the user interface to display the restriction information.

25. A method implementable on a processor of an information processing device comprising a user interface and an operating system (OS), the method comprising:
determining whether an OS setting is enabled, the OS setting being a setting of the OS for restricting use of a device driver provided by a vendor of an image processing device; and
in response to determining that the OS setting is enabled, causing the user interface to display restriction information regarding a restriction on the use of the device driver.

26. An information processing device comprising:
a user interface; and
a controller comprising an operating system (OS), the controller being configured to:
determine whether an OS setting is enabled, the OS setting being a setting of the OS for restricting use of a device driver provided by a vendor of an image processing device; and
in response to determining that the OS setting is enabled, cause the user interface to display restriction information regarding a restriction on the use of the device driver.

27. The information processing device according to claim 26,
wherein the controller comprises:
a processor; and
a non-transitory computer-readable storage medium storing the OS and computer-readable instructions, the computer-readable instructions being configured to, when executed by the processor, cause the controller to:
determine whether the OS setting is enabled; and
in response to determining that the OS setting is enabled, cause the user interface to display the restriction information.
